(19) United States
(12) Patent Application Publication
(10) Pub. No.: US 2022/0131161 A1
(43) Pub. Date: Apr. 28, 2022

(54) HIGH PERFORMING CATHODE CONTACT MATERIAL FOR FUEL CELL STACKS

(71) Applicant: PHILLIPS 66 COMPANY, HOUSTON, TX (US)

(72) Inventors: Mingfei Liu, Bartlesville, OK (US); Ying Liu, Bartlesville, OK (US)

(73) Assignee: PHILLIPS 66 COMPANY, HOUSTON, TX (US)

(21) Appl. No.: 17/449,835

(22) Filed: Oct. 4, 2021

Related U.S. Application Data
(60) Provisional application No. 63/106,628, filed on Oct. 28, 2020.

(51) Int. Cl. H01M 8/0236

(52) U.S. Cl. CPC H01M 8/0236

(57) ABSTRACT

A fuel cell comprising an indium tin oxide cathode contact is in physical contact subjacent an upper interconnect and in physical contact superjacent a cathode. In this fuel cell an electrolyte is in physical contact subjacent a cathode and superjacent an anode. Finally, a lower interconnect is subjacent the anode.

### CROSS-REFERENCE TO RELATED APPLICATIONS

This application is a non-provisional application, which claims the benefit of and priority to U.S. Provisional Application Ser. No. 63/106,628 filed Oct. 28, 2020 entitled “High Performing Cathode Contact Material for Fuel Cell Stacks,” which is hereby incorporated by reference in its entirety

### STATEMENT REGARDING FEDERALLY SPONSORED RESEARCH OR DEVELOPMENT

None.

### FIELD OF THE INVENTION

This invention relates to the area of fuel cell stacks.

### BACKGROUND OF THE INVENTION

In a fuel cell stack, individual cells are connected in series using interconnects to increase the voltage and power output. Under fuel cell operating condition, the voltage will be reduced due to the resistances of the fuel cells, interconnects, and interfacial contact between cells and interconnects. These resistances represent electricity being lost to heat during operation, which should be minimized to improve the stack output. Among the different resistances, the cathode-interconnect interfacial resistance contributes to about 50% of the total loss, which limits the stack performance. In addition, the stack stability is influenced by the stability of the cathode contact material under operating conditions.

Under conventional systems use of porous La_{0.6}Sr_{0.4}Co_{0.2}Fe_{0.8}O₃(LSCF) as a cathode contact material only provides about 8 S/cm. Others have attempted to solve this problem by using precious metal mesh/gauze or ceramic oxide coated high temperature alloy mesh/gauze together with conventional cathode materials, but this method significantly increases materials costs for fuel cells. Other ceramics have been tested instead of LSCF, such as La_{0.6}Sr_{0.4}CoO₃ (LSC) and Sr_{0.5}Sr_{0.5}CoO₃ (SSC), but often suffer from drawbacks such as high conductivity but lower stability. Additionally, LSC and SSC have much higher thermal expansion coefficients than other SOFC components. Furthermore, LSCF, LSC, and SSC are all deteriorated by Cr vapor from metal interconnects which causes conductivity decrease and long-term degradation over time. There exists a need for a new cathode contact material for fuel cell stacks, such as solid oxide fuel cell or solid oxide electrolysis cells.

### BRIEF SUMMARY OF THE DISCLOSURE

A fuel cell comprising an indium tin oxide cathode contact layer is in physical contact subjacent an upper interconnect and in physical contact superjacent a cathode. In this fuel cell an electrolyte is in physical contact subjacent a cathode and superjacent an anode. Finally, a lower interconnect is subjacent the anode.

### BRIEF DESCRIPTION OF THE DRAWINGS

FIG. 1 depicts an embodiment of our novel fuel cell.

FIG. 2 depicts the impact of two different cathode contact layers on stack stability with 4″×6″ cells at 700° C. under constant current of 22 A.

FIG. 3a depicts the cross-sectional view of SSC contact layer on stainless steel interconnect after long term test.

FIG. 3b depicts the elemental distribution maps of SSC contact layer on stainless steel interconnect after long term test.

FIG. 4a depicts the cross-sectional view of ITO contact layer on stainless steel interconnect after long term test.

FIG. 4b depicts the elemental distribution maps of ITO contact layer on stainless steel interconnect after long term test.

FIG. 5 depicts the results of conductivity testing on LSCF, LSM, and ITO powders.

FIG. 6 depicts the conductivity of ITO powders at different temperatures.

FIG. 7 depicts the short-term stability of two different cathode contact layers on cell stability at 650° C. under constant voltage of 0.8

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

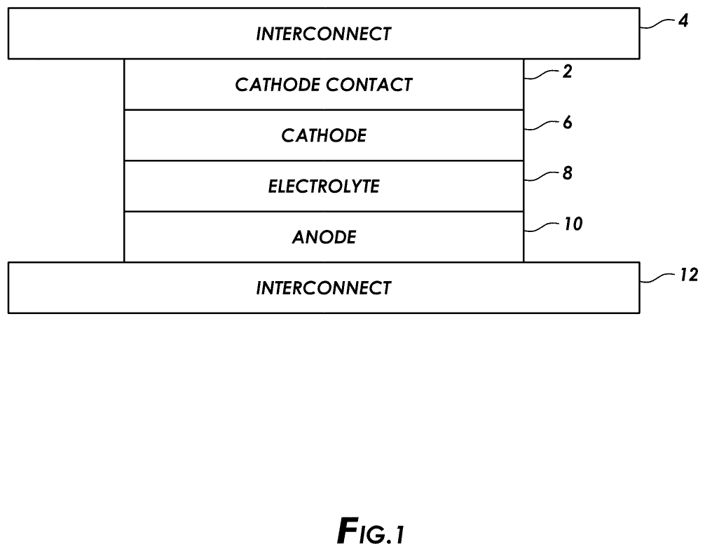

As shown in FIG. 1, the present embodiment describes a fuel cell comprising an indium tin oxide cathode contact 2 is in physical contact subjacent an upper interconnect 4 and in physical contact superjacent a cathode 6. In this fuel cell an electrolyte 8 is in physical contact subjacent a cathode and superjacent an anode 10. Finally, a lower interconnect 12 is subjacent the anode.

In one embodiment, the indium tin oxide cathode contact has a thickness from about 20 μm to about 200 μm, or even from about 100 μm to about 200 μm. In another embodiment, the indium tin oxide cathode contact is porous. In yet another embodiment, no electrochemical reactions occur within the indium tin oxide cathode contact. It is theorized that the higher conductivity of the cathode contact material translates to lower contact resistance loss from the cathode-interconnect interface and higher power output of fuel cell stacks. Additionally, ITO is stable under CO₂ and H₂O environments and shows high resistance to Cr-poisoning. In one embodiment, it is theorized that the indium tin oxide cathode contact can function as a Cr-getter in the fuel cell stack to trap the Cr vapor from forming in the balance of power components and in metal upper interconnect and metal lower interconnect. Furthermore, ITO has similar thermal expansion coefficient (TEC) to the other fuel cell components, around 9.2×10⁻⁶/K. Finally, the economics of indium tin oxide are beneficial over conventional, LSCF, SSC, and LSC.

The upper interconnect and the lower interconnect can be independently selected from any conventionally known metal or ceramic interconnect. Interconnects are used to provide electrical connection between the individual cells of the fuel cell and act as a physical barrier to separate the fuel from oxidant gases. Examples of interconnects that can be used include ferritic stainless steels, other high temperature alloy that resist oxidation and ceramic interconnects.

The cathode for the fuel cell can be any conventionally known cathode used for fuel cells. Examples of cathode material can include materials that are typically used include perovskite-type oxides with a general formula of ABO₃. In this embodiment the A cations are typically rare earths doped with alkaline earth metals including La, Sr, Ca, Pr or Ba. The B cations can be metals such as Ti, Cr, Ni, Fe, Co, Cu or Mn. Examples of these perovskite-type oxides include LaMnO₃. In one differing embodiment the perovskite can be doped with a group 2 element such as Sr²⁺ or Ca²⁺. In another embodiment cathodes such as Pr_{0.5}Sr_{0.5}FeO₃; Sr_{0.9}Ce_{0.1}Fe_{0.8}Ni_{0.2}O₃; Sr_{0.8}Ce_{0.1}Fe_{0.7}Co_{0.3}O₃; LaNi_{0.6}Fe_{0.4}O₃; Pr_{0.8}Sr_{0.2}Co_{0.2}Fe_{0.8}O₃; Pr_{0.7}Sr_{0.3}Co_{0.2}Mn_{0.8}O₃; Pr_{0.8}Sr_{0.2}FeO₃; Pr_{0.6}Sr_{0.4}Co_{0.8}Fe_{0.2}O₃; Pr_{0.4}Sr_{0.6}Co_{0.8}Fe_{0.2}O₃; Pr_{0.7}Sr_{0.3}Co_{0.9}Cu_{0.1}O₃, Ba_{0.5}Sr_{0.5}Co_{0.8}Fe_{0.2}O₃; Sm_{0.5}Sr_{0.5}CoO₃ (SSC); or LaNi_{0.6}Fe_{0.4}O₃ can be utilized. Other materials that the cathode could be include lanthanum strontium iron cobalt oxide, doped ceria, strontium samarium cobalt oxide, lanthanum strontium iron oxide, lanthanum strontium cobalt oxide, barium strontium cobalt iron oxide, or doped double layer Pr₂NiO₄ cathodes, PSZ, YSZ, SSZ, SDC, Ce doped SSZ, GDC, doped barium zirconaie/cerate or combinations thereof.

The anode for the fuel cell can be any conventionally known anode used for fuel cells. Examples of anode material can include mixtures of NO, yttria-stabilized zirconia, gadolinium-doped ceria, SSZ, SDC, Ce doped. SSZ, doped barium zirconate/cerate, CuO, CoO and FeO. Other more specific examples of anode materials can be a mixture of 50 wt. % NiO and 50 wt. % yttria-stabilized zirconia or a mixture of 50 wt. % NiO and 50 wt. % gadolinium-doped ceria.

The electrolyte for the fuel cell can be any conventionally known electrolyte used for fuel cells. Examples of electrolytes include: PSZ, YSZ, SSZ, SDC, GDC, Barium-Zirconium-Cerium-Yttrium-Ytterbium Oxide (BZCYYb), doped barium zirconate/cerate or combinations thereof.

The following examples of certain embodiments of the invention are given. Each example is provided by way of explanation of the invention, one of many embodiments of the invention, and the following examples should not be read to limit, or define, the scope of the invention.

### Example 1

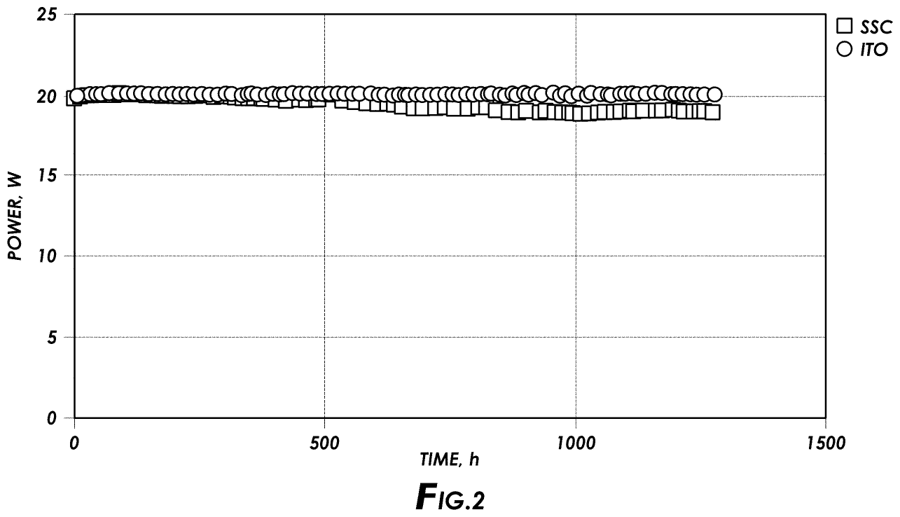

To reduce the chemical driving force for the Cr diffusion, a new electronic conductor, indium tin oxide was evaluated as the cathode contact material for fuel cell stack testing (4″×06″ cell). The ITO contact layer greatly improved the stability of the stack with ferric stainless-steel interconnects, as shown in FIG. 2. No power degradation was detected even after testing at 700° C. for 1,200 h.

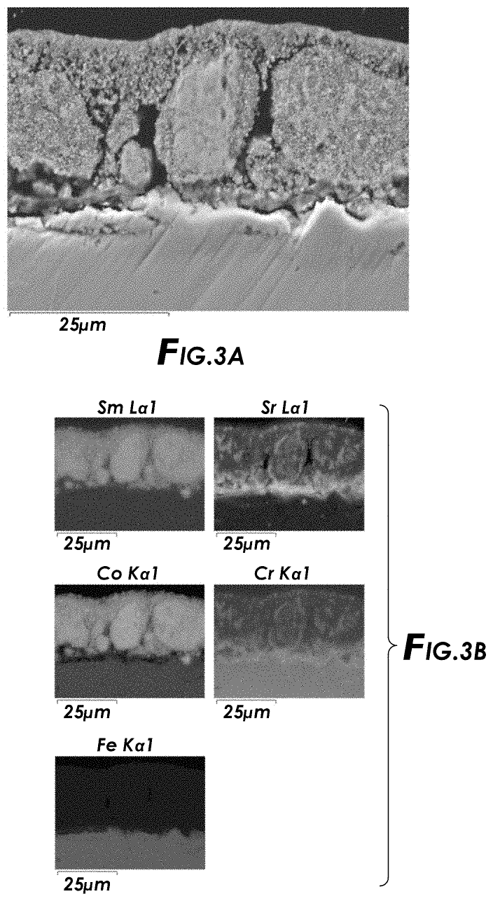

The ferric stainless steel/SSC interface was subjected to long term testing and was analyzed by the SEM-EDX. Cr was detected at the interface in the SSC contact layer (FIG. 3). FIG. 3a depicts the cross-sectional view of SSC contact layer on stainless steel interconnect after long term test. FIG. 3b depicts the elemental distribution maps of SSC contact layer on stainless steel interconnect after long term test.

Significant accumulations of Cr and Sr were detected at the interface of ferric stainless steel/SSC, strongly suggesting that the formation of SrCrO₄. The high chemical reactivity promoted the surface cation segregation processes. The concentrated Sr and Cr were observed at the interface between SSC and the interconnect as well as on the SSC. The formation of the SrCrO₄ not only changed the surface morphology of the cathode, but also affected the electrical and mechanical characteristics, leading to reduced conductivity and electro-catalytic activity of the cathode, resulting in cell performance decay over time. reactivity between Cr and ITO dramatically reduced the chemical potential for Cr diffusion.

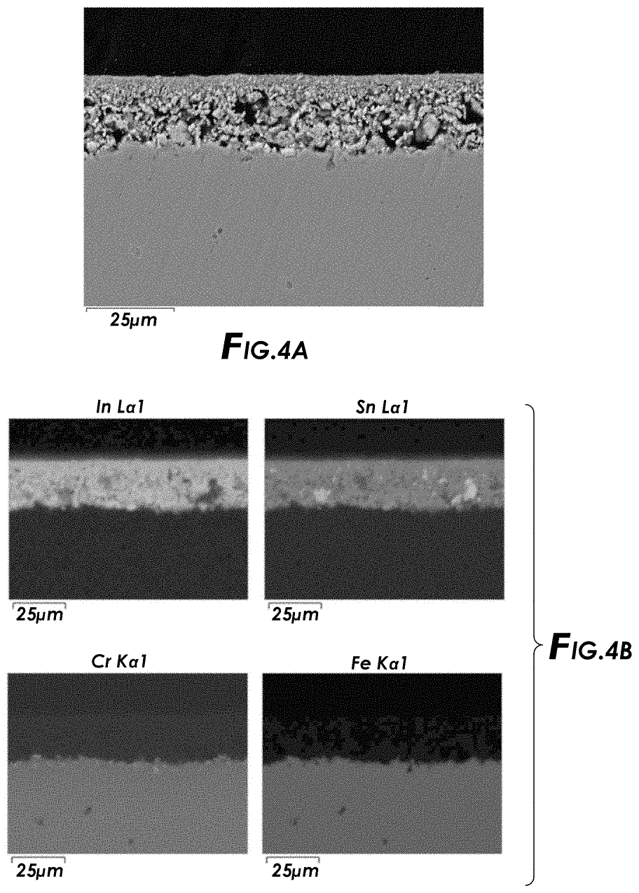

The ferric stainless steel/SSC and the ferric stainless-steel ITO interface was subjected to long term testing and was analyzed by the SEM-EDX. Unlike the ferric stainless steel/SSC interface, no Cr was detected at the interface nor in the ITO contact layer (FIG. 4). FIG. 4a depicts the cross-sectional view of ITO contact layer on stainless steel interconnect after long term test. FIG. 4b depicts the elemental distribution maps of ITO contact layer on stainless steel interconnect after long term test.

It is theorized that the lower chemical reactivity between Cr and ITO dramatically reduced the chemical potential for Cr diffusion.

### Example 2

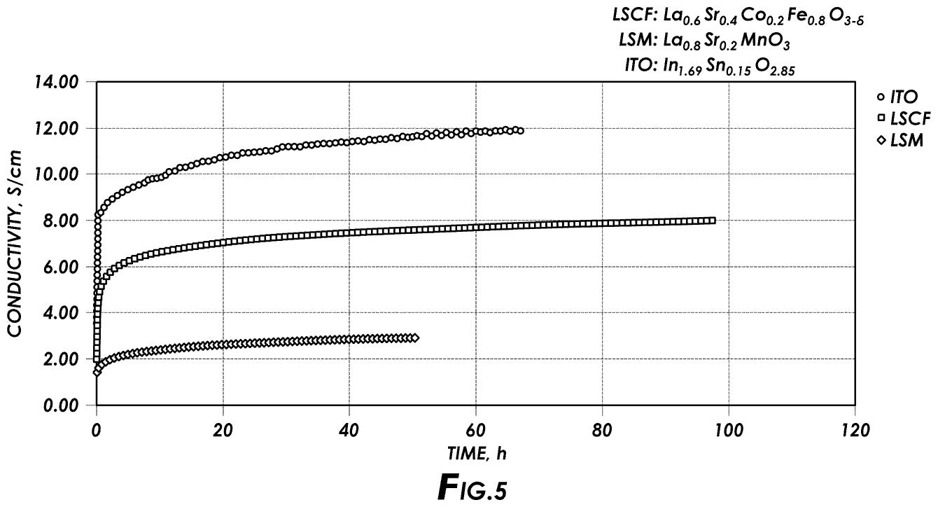

The conductivity of LSCF, LSM, and ITO powders were tested by compressing the powders into an alumina tubing and tested at different temperatures with a four-probe method. The results of this testing are shown in FIG. 5. As depicted ITO was about 50% higher than that of LSCF and 400% higher than that of LSM under same testing conditions.

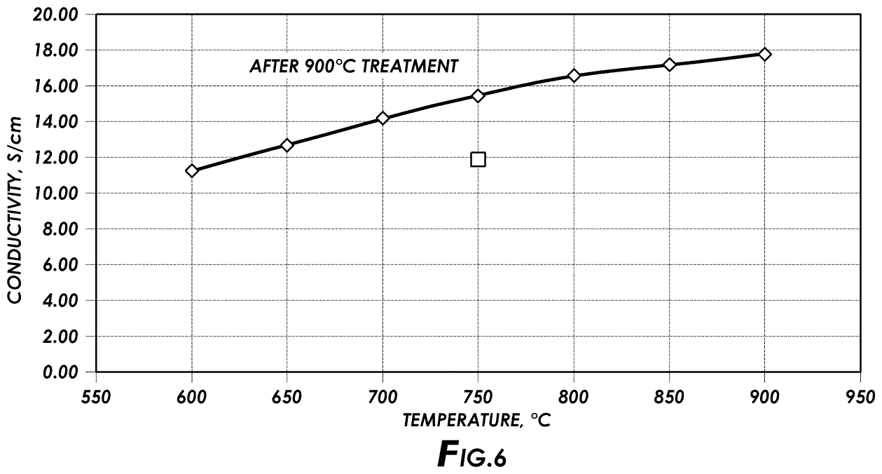

FIG. 6 depicts the conductivity of ITO at different temperatures. This adds to the assumption that the conductivity of ITO can improve by sintering the temperature of the fuel cell stack at higher temperatures. Therefore, in one non-limiting example, the fuel cell stack is sintered at temperatures higher than 750° C., 800° C., even 850° C.

### Example 3

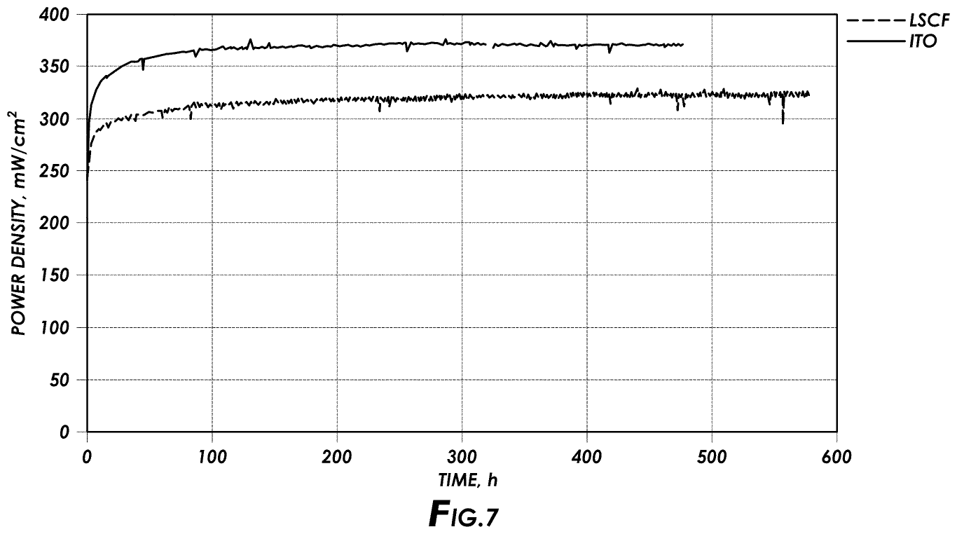

Additionally, the performance and stability of a 2″×2″ cell with ITO contact was done and compared to that of LSCF. As shown in FIG. 7, The cell comprising the ITO contact outperformed the cell with LSCF. The cells were tested at 650° C. under constant voltage of 0.8 V with hydrogen fuel.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A fuel cell comprising:
an indium tin oxide cathode contact in physical contact subjacent an upper interconnect and in physical contact superjacent a cathode;
an electrolyte in physical contact subjacent a cathode and superjacent an anode;
and a lower interconnect subjacent the anode.

2. The fuel cell of claim 1, wherein the indium tin oxide cathode contact has a thickness from about 20 μm to about 200 μm.

3. The fuel cell of claim 1, wherein the indium tin oxide cathode contact has a resistance to Cr-poisoning.

4. The fuel cell of claim 1, wherein the fuel cell does not show any power degradation at 700° C. for 1,200 h.

5. The fuel cell of claim 1, wherein the fuel cell is sintered at temperatures higher than 750° C.

6. The fuel cell of claim 1, wherein no electrochemical reactions occur within the indium tin oxide cathode contact

7. A fuel cell comprising:
a porous indium tin oxide cathode contact in physical contact subjacent an upper interconnect and in physical contact superjacent a cathode, wherein the indium tin oxide has a thickness from about 20 μm to about 200 μm and wherein no electrochemical reactions occur within the porous indium tin oxide cathode contact;
an electrolyte in physical contact subjacent a cathode and superjacent an anode;
and a lower interconnect subjacent an anode.
